(19) United States
(12) Patent Application Publication
(10) Pub. No.: US 2004/0051978 A1
(43) Pub. Date: Mar. 18, 2004

(54) Optical scanning system apparatus

(76) Inventors: Michael Withers, Cambridge (GB); David Billington, Northants (GB); John Cassells, Cambs (GB)

Correspondence Address: EDWARDS & ANGELL, LLP, P.O. BOX 9169, BOSTON, MA, 02209, US

(21) Appl. No.: 10/450,876

(22) PCT Filed: Dec. 14, 2001
(86) PCT No.: PCT/GB01/05565

(30) Foreign Application Priority Data
Dec. 15, 2000 (EP) 00311288.5

(51) Int. Cl. G02B 7/02

(52) U.S. Cl. 359/818

(57) ABSTRACT

An apparatus for use with an optical scanning or observation system. The apparatus comprises a drawer for receiving, in use, a sample carrier to be scanned or observed. A first clamp member, engages, in use, with one surface of a sample carrier in the drawer. A second clamp member is arranged to engage, in use, with the side of the sample carrier opposite to that of the first clamp member, the second clamp member having an optical window formed therein to enable viewing, in use, of a sample carrier. The first and second clamping members are arranged in use to move the sample carrier out of engagement with the drawer so that the sample carrier is supported solely on the clamping members.

This application relates to optical observation systems and an apparatus for use therein.

There are many applications in which it has become necessary to scan or observe samples optically in order to perform some form of visual analysis of the sample. Obviously, many such scanning or observation systems have been known for many years. A simple microscope is a well known laboratory device, for example. In recent times, however, there has been an increased demand for automated optical observation of samples, not only with human observation, but also with automated observation by photo-multiplier tubes, cameras, CCD's etc.

High resolution imaging/scanning/observation systems have a small depth of focus, typically of the order of a few tens of microns. A common problem encountered with the use of high resolution systems is that the surface being imaged/scanned/observed can vary by an amount in excess of the depth of focus. A typical example is a standard clear-bottomed microplate used for drug discovery applications. These are designed to be disposable, and it is not economic to produce microplates with sufficient flatness for high resolution systems. Such microplates typically have a recessed base so that they are supported around the outside of the plate in use. When supported in this way the surface to be scanned/imaged/observed in the recessed base may vary by as much as 500 microns across the microplate. An imaging/scanning/observation system having a depth of focus of, for example ±25 microns cannot therefore view all areas of the plate without having to be refocused.

Manual refocusing is not viable for high throughput systems, so alternative solutions have to be found. One known approach is to make the base of the sample carrier being observed very flexible, preferably through the use of a clear plastic film. This plastic film may be compliant enough to be sucked down under vacuum onto a closely toleranced glass window. Thus the tolerance of the disposable device is reduced to the thickness of the film and the underlying tolerance of the glass. This provides a solution to the general problem outlined above, but is not applicable to rigid sample carriers such as microplates or microscope slides.

An alternative solution is to provide active focussing by measuring the distance between the sample and the observation/scanning optics by for example the use of an infra-red distance measurement system (commonly used in cameras) to track the base of the sample carrier and adjust the point of focus by means of a telescope or other optical adjustment device. This process slows down the rate at which the sample can be observed/scanned because of the need for the mechanical/optical system to make adjustments between each observation. If the sample carrier is a high density microplate, such as a 1536-well plate, the measurement and refocusing procedure will have to be repeated up to 1536 times in reading a single plate. It is possible to reduce the number of times refocusing is performed by refocusing only every few wells (for example three), but this still involves a considerable time overhead per microplate observed. A variation of this technique is to map the x, y and z co-ordinates of the carrier by performing a pre-scan. These co-ordinates are then used to drive the focussing system during the analysis scan. The disadvantage of this approach is that the drawer on which the carrier is placed is subject to mechanical play, and will not give exactly the same x, y and z co-ordinates when scanned for a second time.

A further disadvantage common to all methods of active focus control is the inevitable hysteresis in the mechanical focussing systems, and the increased wear produced by constantly moving the focussing system. These systems are also expensive, requiring some means of measuring displacement.

The present invention seeks to overcome some of the above problems and provides a low cost means of focussing an observation, scanning or imaging system onto a sample carrier such as a microscope slide or microplate that is both rapid and capable of high accuracy. The method of the invention also reduces wear in the mechanical system to a minimum.

According to the present invention there is provided an apparatus for use with an optical observation system, the apparatus comprising:

a drawer for receiving and supporting, in use, a sample carrier to be observed;

a first clamp member, for engaging, in use, with one surface of a sample carrier in the drawer; and

a second clamp member arranged to engage, in use, with the side of the sample carrier opposite to that of the first clamp member, the second clamp member having an optical window formed therein to enable viewing, in use, of a sample carrier;

wherein the first and second clamping members are arranged in use to move the sample carrier out of engagement with the supporting drawer so that the sample carrier is supported solely on the clamping members.

The apparatus may further comprise a datum to establish a fixed point of focus with optionally an adjustable optical system to vary the point of focus relative to this datum.

Optical viewing of the sample carrier can be performed when it is held by the clamping members, with a selected portion of the sample carrier being viewed through the optical window on the second clamping member. As the clamping members are holding the entire sample carrier, the area of the sample carrier clamped between the clamping members is orientated parallel to the focus plane of the optical system. The sample carrier may be held at one fixed position relative to the observation, imaging or scanning system if the area to be observed is equal or less to the area the observation, imaging or scanning system can observe in one operation. Alternatively, the sample carrier may be moved relative to the optical system by means of an x, y translation stage or drawer mechanism. The sample carrier may be moved over a fixed optical system, or the optical system may be moved relative to a fixed sample carrier or a combination of both.

The first clamping member may be positioned, in use, above or below the sample carrier. The drawer may include clamps for retaining the horizontal position of the sample carrier within the drawer during movement of the drawer. In most cases the clamping members will be in a fixed x, y position with the sample carrier being moved in x and y relative to the position by the drawer, although this is not essential.

The second clamp member may be a stationary anvil, and its engagement with the sample carrier is provided by movement of the drawer.

Optical viewing or observation may include observing an image by machine or the eye, recording or observing an image using, for example, a scanner or charge coupled device (CCD), or other means of optical observation, e.g. spectrophotometry.

One example of the present invention will now be described with reference to the accompanying drawings, in which:

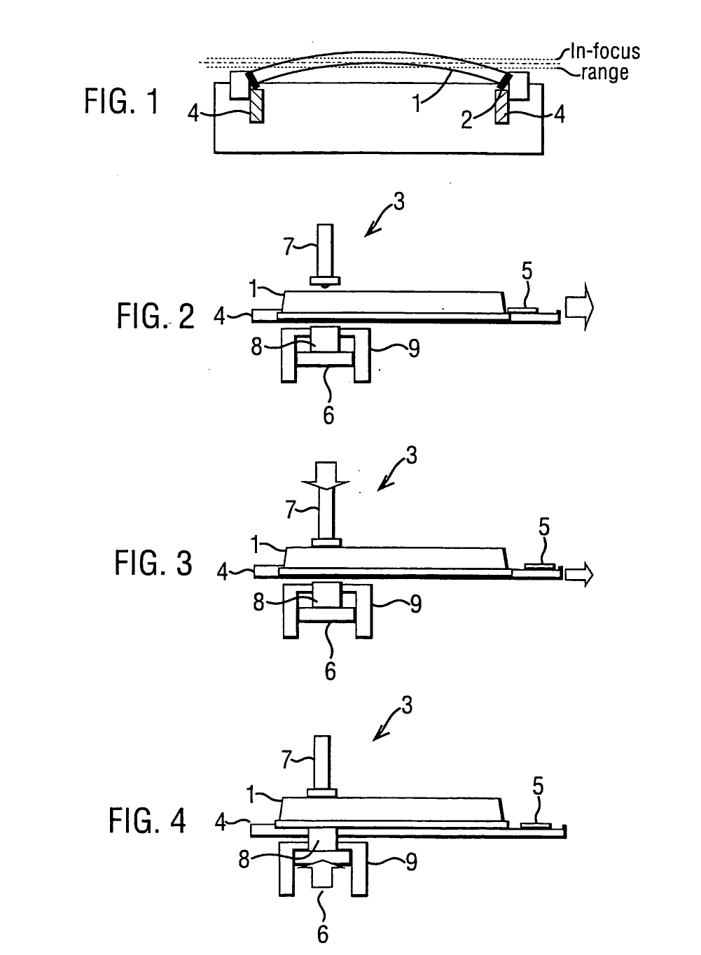

FIG. 1 is a side schematic view of a prior art optical observation system apparatus;

FIG. 2 is a side schematic view of an apparatus according to the invention prior to operation of clamping members;

FIG. 3 is a side schematic view of the example of FIG. 2 during movement of a first vertical clamping member;

FIG. 4 is a side schematic view of the example of FIGS. 2 and 3 during movement of a second vertical clamping member;

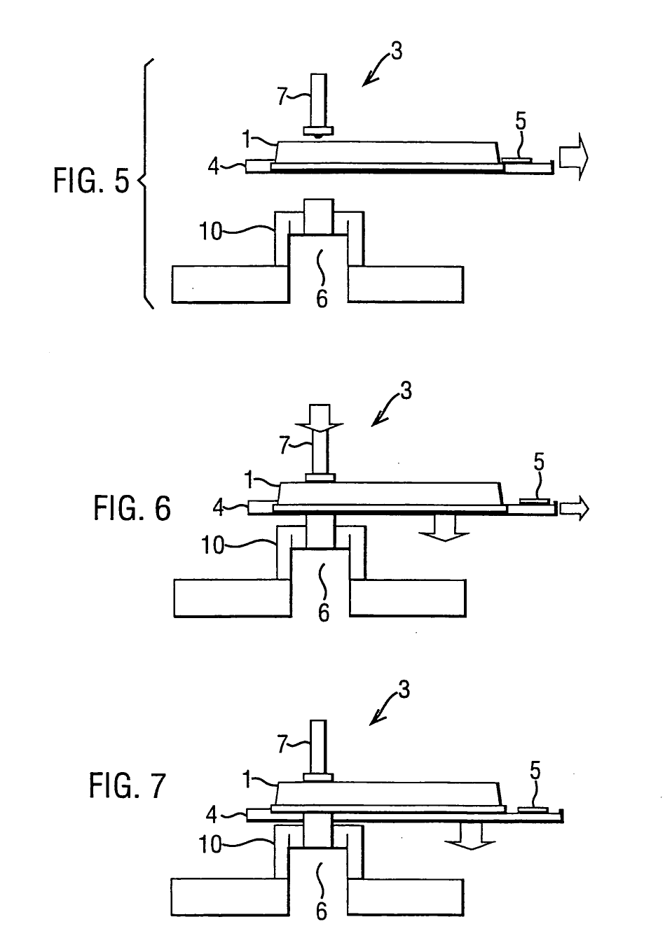

FIG. 5 is a side schematic view of an apparatus according to a second embodiment of the invention prior to operation of a first clamping member and drawer;

FIG. 6 is a side schematic view of the example of FIG. 5 during movement of a first vertical clamping member and drawer;

FIG. 7 is a side schematic view of the example of FIGS. 5 and 6 during continued movement of the drawer; and

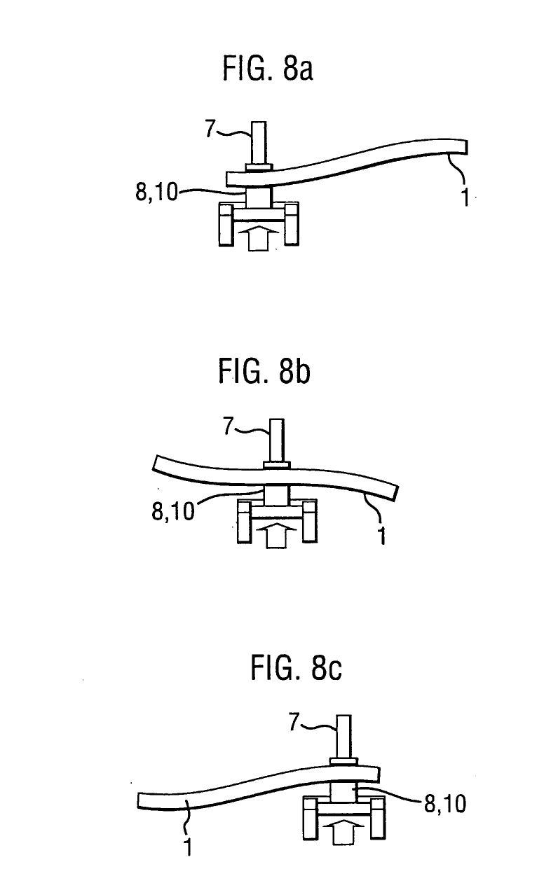

FIGS. 8a to c show side schematic views of a plate when clamped by an apparatus according to either embodiment of the invention.

FIG. 1 shows a prior art optical observation system apparatus of the type described above, in which a microplate 1 has a recessed base having a lip 2 around the edge thereof. The lip 2 is supported by a frame 4 to enable scanning. However, because of limitations in terms of quality of manufacture of the plate 1, it may curve so that certain regions of the plate are outside the in-focus range of the system in which the apparatus is being employed.

Referring to FIG. 2, an apparatus 3 according to the present invention comprises a drawer 4 in which, in use, a sample carrier or plate 1 is positioned. The sample carrier or plate 1 may be a glass slide containing a specimen to be viewed or may be an array of individual storage wells or apertures.

The sample carrier is retained in position by a datum clamp 5, so that when the drawer 4 is moved to enable scanning there is no movement of the sample carrier 1 with respect to the drawer 4, ensuring accurate positioning of the sample(s) for inspection. Individual portions of the sample carrier 1 are inspected in situ via a window 6 by an optical device (not shown), which may be a combination of an illuminating light and camera, illuminating light or microscope, or illuminating light and photo multiplier or other optical system including a spectrophotometer. The illuminating light may, if the sample carrier 1 is totally transparent, be positioned on either side of the sample carrier with respect to the viewing window 6. A first clamp 7 is provided and may be transparent to allow illumination through it, or may be obscure to reduce background light contamination if illumination is arranged from the side opposite to it, as shown.

When a particular portion of the sample carrier 1 has been selected for viewing, the drawer 4 is moved relative to the window 6 to position the appropriate portion of the sample carrier 1 within the window 6. Following this the first clamp 7 is moved downward onto the surface of the sample carrier 1, and the datum clamp 5 is removed.

A second clamping member 8, which surrounds the viewing window 6, is then moved into engagement with the opposite surface of the sample carrier 1 to the one acted on by the first clamp 7. Continued movement of the second clamp 8 disengages the sample carrier 1 from the drawer 4, such that the sample carrier 1 is supported only by the two clamps 7, 8. The maximum extension position of the second clamp 8 may be defined by a retaining sleeve 9 in which the second clamping member 8 slides. This provides a datum such that at the maximum extension position the sample carrier 1 is positioned so that it is at an optimum focal point for the inspection system (not shown) being employed.

In a second embodiment of the invention, as may be seen in FIGS. 5 to 7, the second clamp may be formed as a fixed or stationary anvil 10. Again, the anvil 10 surrounds the viewing window 6. FIGS. 5 and 6 show the apparatus of the second embodiment during the positioning of the sample carrier, and the deployment of the first clamping member to contact the sample carrier. Once deployed, the clamping member 7 holds the plate 1 against the drawer 4.

As may be further seen in FIG. 6, the clamping member 7 and the drawer 4 move downwardly together, toward the anvil 10, until the underside of the plate 1 contacts the anvil 10, at which point the datum clamp 5 is removed.

Finally, the plate 1 is retained in its position by the anvil, whilst the drawer is further displaced such that the plate 1 no longer rests upon it, as is shown in FIG. 7. This may be achieved by biasing the clamping member 7 into contact with the drawer 4, such that when the drawer 4 is lowered the clamping member 7 automatically engages the plate 1. Hence, as seen in FIG. 7, biasing pressure is applied to the clamping mechanism, by a biasing spring for example, while the drawer is displaced and moved out of contact with the plate. Observation of the chosen portion of the plate may then take place.

An advantage of the second embodiment is that the anvil 10 is a fixed part and the clamping force of the clamping member can be easily controlled by controlling the extent of downward travel of the drawer to compensate for different plate thickness, stiffness and weight.

Since the second clamping member 8, 10, surrounds the region being viewed through viewing window 6, the clamping done can serve to flatten that region of the sample carrier 1 relative to the focus of the inspection system, thus ensuring that the sample carrier 1 is very flat within the region being viewed, removing a main cause of optical distortion and inaccuracy in scanning. A pictorial representation of this effect is shown in FIGS. 8a to c. Those figures show different regions of the plate 1 being flattened by the clamps 7, 8, 10.

It can be seen that the method and apparatus of the invention can ensure any area of the sample carrier can be positioned as parallel as possible to the plane of focus of the optical system. It may be necessary to adjust the focal point of the optical system to take account of varying thicknesses and different types of sample carrier. For example, different microplates manufacturers may use different thickness plastic films or glass sheet in the base of the microplates. This thickness is generally consistent for one make and specification of microplate. The optical system can be provided with a motorised telescope so that the optical system may be adjusted to focus on a point equal to the fixed datum provided by the invention and the thickness of the base of the sample carrier. This adjustment is only made once per sample carrier type (when the first of a given microplate is used) and the focus position can be determined without the need of an automatic rangefinder. Once this position is set, it may be recorded by an electronic system or fixed mechanically. Wear in the telescope mechanism is greatly reduced because no adjustment is necessary between observations. It can also be seen that the present invention avoids the need to make continuous measurements and adjustments for the focussing system when scanning the whole surface of the sample carrier.

1. An apparatus for use with an optical observing system, the apparatus comprising:
a drawer for receiving and supporting, in use, a sample carrier to be observed;
a first clamp member, for engaging, in use, with one surface of a sample carrier in the drawer; and
a second clamp member arranged to engage, in use, with the side of the sample carrier opposite to that of the first clamp member, the second clamp member having an optical window formed therein to enable viewing, in use, of a sample carrier;
wherein the first and second clamping members are arranged in use to move the sample carrier out of engagement with the supporting drawer so that the sample carrier is supported solely on the clamping members.

2. An apparatus according to claim 1, wherein the first clamping member is positioned, in use, above the sample carrier.

3. An apparatus according to claim 1 or claim 2, wherein the drawer includes a clamp for retaining the horizontal position of the sample carrier within the drawer during movement of the drawer.

4. An apparatus according to any preceding claim, wherein, the clamping members are fixed with respect to the drawer, which is moveable.

5. An apparatus according to any preceding claim, wherein the second clamp member is a stationary anvil, and wherein its engagement with the sample carrier is provided by movement of the drawer.

6. An apparatus according to any preceding claim, further comprising a datum to enable, in use, the establishment of a fixed point of focus.

7. An apparatus according to any preceding claim, wherein viewing, in use, is carried out utilising one of image observing means including an eye or a viewing mechanism, image recording means such as a scanner or charge coupled device, or other optical detection means such as a spectrophotometer.

8. An optical observing system comprising an apparatus according to any preceding claim.
